(19) United States
(12) Patent Application Publication
(10) Pub. No.: US 2021/0088940 A1
(43) Pub. Date: Mar. 25, 2021

(54) IMAGE FORMING APPARATUS

(71) Applicant: FUJI XEROX CO., LTD, Tokyo (JP)

(72) Inventors: Haruka Kobayashi, Kanagawa (JP); Daisuke Tanaka, Kanagawa (JP)

(73) Assignee: FUJI XEROX CO., LTD., Tokyo (JP)

(21) Appl. No.: 16/820,042

(22) Filed: Mar. 16, 2020

(30) Foreign Application Priority Data
Sep. 20, 2019 (JP) 2019-171197

(51) Int. Cl. G03G 15/16

(52) U.S. Cl. CPC G03G 15/161

(57) ABSTRACT

An image forming apparatus includes a belt, an inner surface supporter, a transfer unit, a guide unit, and a guide controller. The belt holds and transports a toner image on an outer surface thereof. The inner surface supporter presses an inner surface of the belt, rotates about a first rotation shaft, and swells the belt toward the outer surface. The transfer unit rotates about a second rotation shaft while holding the belt between the transfer unit and the inner surface supporter, and presses a sheet transported thereto against the belt to transfer a toner image on the belt to the sheet. The guide unit guides the sheet transported thereto to an area interposed between the belt and the transfer unit. The guide controller controls a position or an orientation of the guide unit so that a sheet contact point at which a leading end of the transported sheet comes into contact with the belt is located closer to the first rotation shaft, as the guided sheet is thinner, in a reference direction from the second rotation shaft to the first rotation shaft.

### CROSS-REFERENCE TO RELATED APPLICATIONS

This application is based on and claims priority under 35 USC 119 from Japanese Patent Application No. 2019-171197 filed Sep. 20, 2019.

### BACKGROUND

### (i) Technical Field

The present disclosure relates to an image forming apparatus.

### (ii) Related Art

An image forming apparatus including a so-called intermediate transfer belt is known. This type of image forming apparatus transfers a toner image on a belt to a sheet transported to the image. A variety of structures for guiding sheets transported along a predetermined path have been developed for an image forming apparatuses (refer to, for example, Japanese Unexamined Patent Application Publication Nos. 2009-196803, 2013-015551, and 2016-004129).

### SUMMARY

When the above type of image forming apparatus transfers a toner image on a belt to a sheet transported to the toner image, the sheet undergoing transfer may adhere to the belt to deviate from a regular transport path, particularly when the sheet is a thin sheet.

Aspects of non-limiting embodiments of the present disclosure relate to an image forming apparatus that prevents sheets undergoing transfer from adhering to a belt regardless of the thickness of the sheets.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus that includes a belt, an inner surface supporter, a transfer unit, a guide unit, and a guide controller. The belt holds and transports a toner image on an outer surface thereof. The inner surface supporter presses an inner surface of the belt, rotates about a first rotation shaft, and swells the belt toward the outer surface. The transfer unit rotates about a second rotation shaft while holding the belt between the transfer unit and the inner surface supporter, and presses a sheet transported thereto against the belt to transfer a toner image on the belt to the sheet. The guide unit guides the sheet transported thereto to an area interposed between the belt and the transfer unit. The guide controller controls a position or an orientation of the guide unit so that a sheet contact point at which a leading end of the transported sheet comes into contact with the belt is located closer to the first rotation shaft, as the guided sheet is thinner, in a reference direction from the second rotation shaft to the first rotation shaft.

### BRIEF DESCRIPTION OF THE DRAWINGS

Exemplary embodiments of the present disclosure will be described in detail based on the following figures, wherein:

FIG. 1 illustrates a structure of an image forming apparatus according to an exemplary embodiment of the present disclosure;

FIGS. 2A, 2B, and 2C are schematic diagrams illustrating a structure of a second transfer unit of the image forming apparatus illustrated in FIG. 1; and

FIGS. 3A and 3B are schematic diagrams of structures of a third example (FIG. 3A) and a fourth example (FIG. 3B) of the second transfer unit of the image forming apparatus illustrated in FIG. 1.

### DETAILED DESCRIPTION

An exemplary embodiment of the present disclosure will now be described below with reference to the drawings.

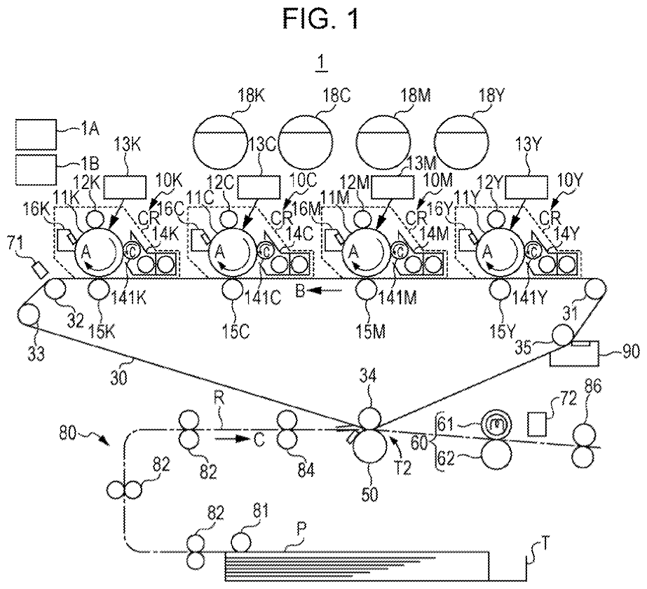

FIG. 1 shows a structure of an image forming apparatus according to an exemplary embodiment of the present disclosure.

An image forming apparatus 1 illustrated in FIG. 1 is a tandem color printer including image forming units 10Y, 10M, 10C, and 10K for yellow (Y), magenta (M), cyan (C), and black (K) arranged in parallel. The image forming apparatus 1 is capable of printing monochrome images and full-color images formed from four-color toner images. Toner cartridges 18Y, 18M, 18C, and 18K accommodate toner of respective Y, M, C, and K colors.

The four image forming units 10Y, 10M, 10C, and 10K have substantially the same structure. Thus, the image forming unit 10Y for yellow is described by way of example. The image forming unit 10Y includes a photoconductor drum 11Y, a charging device 12Y, an exposure device 13Y, a developing device 14Y, a first transfer roller 15Y, and a photoconductor cleaner 16Y. The photoconductor drum 11Y, the charging device 12Y, and the developing device 14Y of the image forming unit 10Y are disposed in a process cartridge CR. The process cartridge CR is removably attached to a body 1H of the image forming apparatus 1.

The photoconductor drum 11Y is formed from a hollow cylindrical body with a photosensitive layer on its surface. The photoconductor drum 11Y carries an image formed on the surface and rotates in a direction of arrow A about the axis of the hollow cylinder. The charging device 12Y, the exposure device 13Y, the developing device 14Y, the first transfer roller 15Y, and the photoconductor cleaner 16Y are arranged in this order around the photoconductor drum 11Y in the direction of arrow A.

The charging device 12Y is a device that charges the surface of the photoconductor drum 11Y. The charging device 12Y according to the present exemplary embodiment is a charging roller that comes into contact with the surface of the photoconductor drum 11Y. The charging device 12Y receives a voltage to charge the surface of the photoconductor drum 11Y with which the charging device 12Y comes into contact. The exposure device 13Y exposes the surface of the photoconductor drum 11Y to exposure light to form an electrostatic latent image on the surface of the photoconductor drum 11Y. The exposure device 13Y emits a laser beam corresponding to image data fed from the outside of the image forming apparatus 1, and scans the photoconductor drum 11Y with the laser beam.

The developing device 14Y includes a development roller 141 that rotates in the direction of arrow C. The development roller 141 transports a developer in the developing device 14Y to a development position that faces the photoconductor drum 11Y. At the development position, the developing device 14Y develops the electrostatic latent image formed on the surface of the photoconductor drum 11Y with the developer transported to the development position to form an unfixed toner image on the surface of the photoconductor drum 11Y. The developing device 14Y receives toner from the toner cartridge 18Y. The developing device 14Y agitates the developer, which is a mixture of a magnetic carrier and toner, to electrically charge the toner and the magnetic carrier, and develops the electrostatic latent image on the photoconductor drum 11Y with the charged toner. The first transfer roller 15Y is a roller facing the photoconductor drum 11Y across an intermediate transfer belt 30.

In response to an application of a voltage to the photoconductor drum 11Y, the first transfer roller 15Y transfers a toner image on the photoconductor drum 11Y to the intermediate transfer belt 30.

The photoconductor cleaner 16Y cleans the surface of the photoconductor drum 11Y by removing remnants such as toner left on the photoconductor drum 11Y after the transfer.

The image forming apparatus 1 also includes a controller 1A, a user interface (UI) 1B, the intermediate transfer belt 30, a fixing unit 60, and a sheet transport unit 80. The controller 1A controls the entirety of the image forming apparatus 1. The controller 1A is an information processor having a function of executing various programs. Each unit of the image forming apparatus 1 is controlled by the controller 1A executing a control program. The controller 1A also has a function of receiving image data transmitted from the outside of the image forming apparatus 1, such as a personal computer (hereinafter abbreviated to “PC”). The image forming apparatus 1 forms images based on the received image data on a sheet under the control of the controller 1A.

The UI 1B includes, for example, a display screen and a press button to enable information exchange between the image forming apparatus 1 and a user. The UI 1B may include a touch screen, instead.

The intermediate transfer belt 30 is an endless belt wound around belt support rollers 31 to 35 including a back-up roller 34. The intermediate transfer belt 30 circularly moves in the direction of arrow B along a transport path, passing the image forming units 10Y, 10M, 10C, and 10K and a second transfer unit T2. The intermediate transfer belt 30 receives toner images of respective colors from the image forming units 10Y, 10M, 10C, and 10K transferred thereto. The intermediate transfer belt 30 moves while carrying toner images of these colors.

The second transfer unit T2 includes a second transfer roller 50 at a position facing the back-up roller 34 across the intermediate transfer belt 30. The second transfer roller 50 is a roller that rotates while holding the intermediate transfer belt 30 and the sheet P between itself and the back-up roller 34 of the belt support rollers 31 to 35. The surface of the second transfer roller 50 is formed from an elastic material. The second transfer roller 50 is pressed against the intermediate transfer belt 30 to form a nip area, in which the second transfer roller 50 and the intermediate transfer belt 30 are in contact. In the second transfer unit T2, the sheet P is nipped in the nip area, and a voltage having a polarity opposite to the polarity of a voltage with which toner is charged is applied to the nip area. Thus, the toner image on the intermediate transfer belt 30 is transferred to the sheet P.

The fixing unit 60 fixes a toner image onto the sheet P. The fixing unit 60 includes a heat roller 61 and a pressure roller 62, and the heat roller 61 incorporates a heater. The heat roller 61 and the pressure roller 62 rotate in directions in which they further transport the sheet P transported thereto while carrying an unfixed toner image, and heat and press the sheet P while holding the sheet P therebetween. The fixing unit 60 thus fixes the unfixed toner image onto the sheet P, and transports the sheet P further downstream in the transport direction.

The sheet transport unit 80 includes a pick-up roller 81, which picks up the sheets P accommodated in the sheet container T, transport rollers 82, which transport the picked-up sheets P, registration rollers 84, which transport the sheets P toward the second transfer unit T2 where the second transfer roller 50 is disposed, and discharge rollers 86, which discharge the sheets P to the outside. The sheet transport unit 80 transports the sheets P along a sheet transport path R, passing the second transfer unit T2 and the fixing unit 60. Here, information of the basis weight, or the thickness, of the sheets P specified by the name of the sheets P accommodated in the sheet container T, such as an ordinary sheet or cardboard, is input in advance to the image forming apparatus 1. Specifically, an ordinary sheet is preset. When a user places a different type of sheets P in the sheet container T, the user inputs the type of the sheets P placed in the sheet container T through the UI 1B. Information of the type of the sheets P is stored in the controller 1A.

The image forming apparatus 1 includes a density sensor 71, which measures the density of a toner image on the intermediate transfer belt 30, and a line sensor 72, which measures the density of the image on the sheet P that has passed the fixing unit 60. This image forming apparatus 1 forms a toner patch on the intermediate transfer belt 30 and measures the density of the toner patch with the density sensor 71 during an image-formation inactivated period in which image formation based on image data received from a PC or other devices is inactivated. The measurement data is transmitted to the controller 1A to adjust the density of an image formed based on the image data received from a PC or other devices.

The line sensor 72 includes a structure including multiple sensors arranged in the sheet width direction (main scanning direction). The line sensor 72 monitors images formed on the sheet P that passes thereover, and measures, for example, the density of images formed on the sheet P. The measurement data is transmitted to the controller 1A, and the controller 1A monitors whether the image has density or hue within specifications.

The basic operation of the image forming apparatus 1 illustrated in FIG. 1 will be described.

In the yellow image forming unit 10Y, the photoconductor drum 11Y is driven to rotate in the direction of arrow A, and the surface of the photoconductor drum 11Y is electrically charged by the charging device 12Y. The exposure device 13Y irradiates the photoconductor drum 11Y with exposure light according to data of the corresponding color in the image data. The exposure device 13Y irradiates the surface of the photoconductor drum 11Y with exposure light based on the image data corresponding to yellow among the image data fed from the outside to form an electrostatic latent image on the surface of the photoconductor drum 11Y. The developing device 14Y receives yellow toner from the toner cartridge 18Y. The developing device 14Y develops the electrostatic latent image on the photoconductor drum 11Y with toner to form a toner image. The photoconductor drum 11Y rotates while carrying the yellow toner image formed on its surface. The toner image formed on the surface of the photoconductor drum 11Y is transferred to the intermediate transfer belt 30 by the first transfer roller 15Y. After transfer, toner left on the photoconductor drum 11Y is removed by the photoconductor cleaner 16Y.

The intermediate transfer belt 30 circularly moves in the direction of arrow B. As in the case of the image forming unit 10Y, the image forming units 10M, 10C, and 10K for colors other than yellow form toner images of corresponding colors, and transfer the toner images of the corresponding colors to the intermediate transfer belt 30 on the toner image transferred by the image forming unit 10Y.

The sheets P are picked up from the sheet container T by the pick-up roller 81. Each sheet P is transported by the transport rollers 82 and the registration rollers 84 along the sheet transport path R in the direction of arrow C toward the second transfer unit T2. The registration rollers 84 feed the sheet P to the second transfer unit T2 at the timing at which the toner image is transferred to the intermediate transfer belt 30. The second transfer unit T2 transfers the toner image on the intermediate transfer belt 30 to the sheet P. The sheet P to which the toner image has been transferred is transported from the second transfer unit T2 to the fixing unit 60, and the toner image transferred to the sheet P is fixed to the sheet P. Thus, an image is formed on the sheet P. The sheet P on which an image is formed is transported further while having the image thereon read by the line sensor 72, and discharged to the outside of the image forming apparatus 1 by the discharge rollers 86. Toner left on the intermediate transfer belt 30 after the transfer of the second transfer unit T2 is removed by a belt cleaner 90.

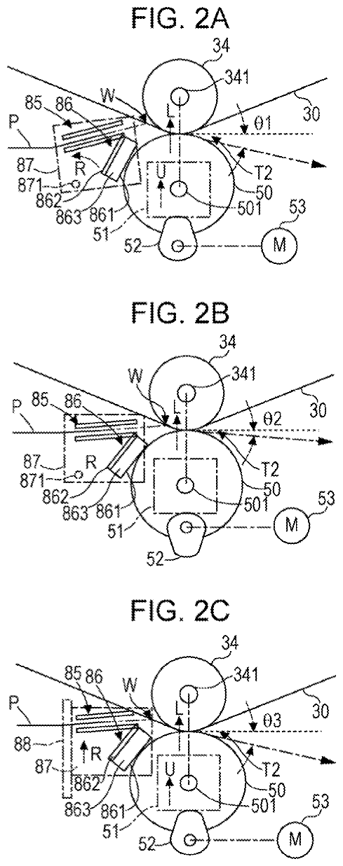

FIGS. 2A, 2B, and 2C are schematic diagrams of the structure of a second transfer unit of the image forming apparatus illustrated in FIG. 1. FIGS. 2A and 2B illustrate a first example of the structure of the second transfer unit. FIG. 2A illustrates an operation of the first example for the case where the sheet container T accommodates sheets P, which are ordinary sheets or sheets thinner than ordinary sheets. FIG. 2B illustrates an operation of the first example for the case where the sheet container T accommodates sheets P, which are thicker than ordinary sheets. FIG. 2C illustrates a second example of the structure of the second transfer unit, which will be described after describing the first example.

In the second transfer unit T2, the back-up roller 34 and the second transfer roller 50 face each other with the intermediate transfer belt 30 interposed therebetween. The back-up roller 34 presses the inner surface of the intermediate transfer belt 30, opposite to the outer surface carrying a toner image, to swell the intermediate transfer belt 30 outward, and rotates about a rotation shaft 341. The second transfer roller 50 holds the intermediate transfer belt 30 between itself and the back-up roller 34, and rotates about a rotation shaft 501. The second transfer roller 50 presses the sheet P transported thereto against the intermediate transfer belt 30 to transfer the toner image on the intermediate transfer belt 30 to the sheet P. Here, the intermediate transfer belt 30 corresponds to an example of a belt in the present disclosure. The back-up roller 34 corresponds to an example of an inner surface supporter in the present disclosure. The rotation shaft 341 thereof corresponds to an example of a first rotation shaft in the present disclosure. The second transfer roller 50 corresponds to an example of a transfer unit in the present disclosure. The rotation shaft 501 thereof corresponds to an example of a second rotation shaft in the present disclosure.

A guide member 85 and a cleaning member 86 are disposed immediately upstream of the second transfer unit T2 in the sheet transport direction. The guide member 85 guides the sheet P transported thereto to a nip area held between the intermediate transfer belt 30 and the second transfer roller 50. The cleaning member 86 cleans the second transfer roller 50 while being in contact with the second transfer roller 50. At least a surface 861, which comes into contact with the second transfer roller 50, of the cleaning member 86 is formed from an elastic material. Specifically, in the present exemplary embodiment, the surface 861 is formed from a sponge 863 bonded to a backing plate 862.

The second transfer roller 50 is rotatably supported by a support member 51 via a bearing, not illustrated. The support member 51 is vertically movable by being pressed by a cam member 52, and is moved upward by being pressed by the cam member 52. The cam member 52 is driven to rotate by a motor 53, and moves the support member 51 upward or downward in accordance with the rotation angle.

The guide member 85 and the cleaning member 86 are fixed to a support member 87. The support member 87 is rotatable about a rotation shaft 871.

FIG. 2A illustrates a case where the sheet container T illustrated in FIG. 1 accommodates sheets P, which are ordinary sheets or sheets thinner than ordinary sheets, and an image is formed on the sheets P. FIG. 2B illustrates a case where the sheet container T accommodates sheets P, which are cardboard thicker than ordinary sheets and having a predetermined thickness or larger, and an image is formed on the sheets P.

When FIGS. 2A and 2B are compared with each other, the cam member 52 is rotated 180 degrees, and the support member 51, which supports the rotation shaft 501 of the second transfer roller 50 is raised upward as indicated with arrow U in FIG. 2A. This drawing shows that the second transfer roller 50 is firmly pressed against the intermediate transfer belt 30 to expand the nip area.

In FIG. 2A, the cleaning member 86 is pressed by the second transfer roller 50, and the support member 87 rotates in the direction of arrow R about the rotation shaft 871, compared with that in FIG. 2B. Accordingly, the cleaning member 86 and the guide member 85 fixed to the support member 87 also rotate in the direction of arrow R.

Here, the direction indicated with arrow L in FIGS. 2A, 2B, and 2C from the rotation shaft 501 of the second transfer roller 50 to the rotation shaft 341 of the back-up roller 34 is referred to as a reference direction. An attention is paid to a sheet contact point W at which the leading end of the transported sheet comes into contact with the intermediate transfer belt 30. When FIGS. 2A and 2B are compared with each other, the sheet contact point W in FIG. 2A is closer to the rotation shaft 341 of the back-up roller 34 in the reference direction.

If the sheet P is a thin sheet, the sheet P after passing through the nip area between the intermediate transfer belt 30 and the second transfer roller 50 is more likely to remain adhering to the intermediate transfer belt 30 without directing toward a regular transport route, than in the case where the sheet P is cardboard. Here, as indicated with angles θ1 and θ2 (θ1>θ2) in FIGS. 2A and 2B, the sheet P that has passed through the nip area is more likely to travel in a direction further away from the intermediate transfer belt 30 as the sheet contact point W is located closer to the rotation shaft 341 of the back-up roller 34. When having the same properties such as a thickness, the sheets P are less likely to remain adhering to the intermediate transfer belt 30 as they travel in a direction further away from the intermediate transfer belt 30.

When the sheet P is cardboard, on the other hand, a high nip pressure, which is a pressing force of the second transfer roller 50 against the intermediate transfer belt 30, causes the sheet to enter the nip area with a large impact, which may cause defects such as disorder of a toner image. Thus, when the sheet P is cardboard, preferably, the nip pressure may be lowered than in the case where the sheet P is an ordinary sheet or a thinner sheet.

Here, using adjustment of the nip pressure, the orientation of the guide member 85 is changed between the case where the sheet P is an ordinary sheet or a thinner sheet and the case where the sheet P is cardboard to adjust the sheet contact point W.

Thus, the second transfer unit T2 is capable of handling various types of sheets ranging from a thin sheet to cardboard.

In the case of the first example illustrated in FIGS. 2A and 2B, when the cleaning member 86 pressed by the second transfer roller 50 changes its orientation, the orientation of the guide member 85, that is, the tilt angle with respect to the reference direction L is controlled. Thus, in the first example, the cleaning member 86 is regarded as an example of a guide controller in the present disclosure. Alternatively, an assembly of the motor 53, the cam member 52, the second transfer roller 50, and the cleaning member 86 may be regarded as an example of a guide controller in the present disclosure.

The cam member 52 and the motor 53 control the pressure exerted from the second transfer roller 50 onto the intermediate transfer belt 30 by moving the second transfer roller 50 toward the intermediate transfer belt 30. The cam member 52 and the motor 53 correspond to an example of a pressure controller in the present disclosure. In the case of the first example, the cleaning member 86, serving as an example of a guide controller, controls the orientation of the guide member 85 in a manner linked with movement control on the second transfer roller 50 performed by the cam member 52 and the motor 53, corresponding to an example of a pressure controller.

In the case of the first example, the cleaning member 86, serving as an example of a guide controller, is coupled to the cam member 52 and the motor 53, corresponding to an example of a pressure controller, with the second transfer roller 50 interposed therebetween. The guide member 85 is controlled by the motor 53, which is a power source shared with the second transfer roller 50 for movement control.

In the case described here, the sheets P are controlled in two separate groups between the sheets P formed from ordinary sheets or thinner sheets and the sheets P formed from cardboard having a predetermined thickness thicker than ordinary sheets. For example, the orientation of the guide member 85 may be controlled in three separate groups between thin sheets thinner than ordinary sheets, ordinary sheets, and cardboard so that the sheet contact point W is shifted closer to the rotation shaft 341 of the back-up roller 34 in the reference direction L as the sheet is thinner. Alternatively, the orientation of the guide member 85 may be controlled in accordance with the thickness of the sheets P without dividing the sheets P into separate groups, such as two or three groups, so that the sheet contact point W is shifted closer to the rotation shaft 341 of the back-up roller 34 as the sheet is thinner. The same holds true for following examples including second and subsequent examples in terms of these points.

In the case of the second example illustrated in FIG. 2C, the support member 87 on which the guide member 85 and the cleaning member 86 are fixed is vertically movably supported by a strut 88. When the cam member 52 rotates, the second transfer roller 50 moves upward and downward, the cleaning member 86 is pressed, and the support member 87 moves upward and downward along the strut 88. In response to the up and down movement, the guide member 85 also moves upward and downward to adjust the sheet contact point W. Thus, the adjustment of the sheet contact point W may be an adjustment of the tilt angle of the guide member 85, as in the first example, or an adjustment of the height position of the guide member 85, as in the second example.

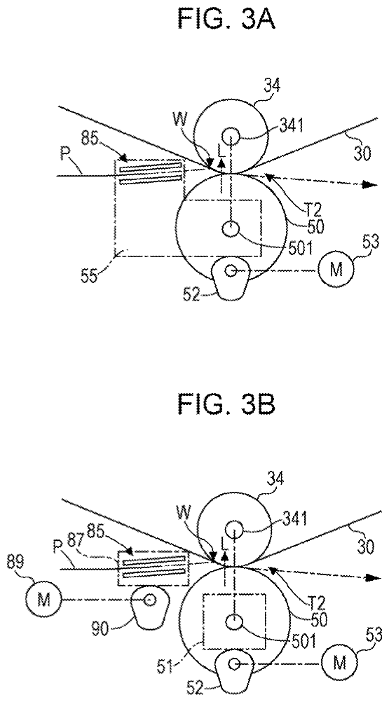

FIGS. 3A and 3B are schematic diagrams of a third example (FIG. 3A) and a fourth example (FIG. 3B) of the second transfer unit of the image forming apparatus illustrated in FIG. 1.

The third example illustrated in FIG. 3A includes a support member 55, which supports the rotation shaft 501 of the second transfer roller 50 and the guide member 85. The cleaning member 86 (refer to FIGS. 2A, 2B, and 2C), which is not involved to control the position or orientation of the guide member 85, is not illustrated here. However, the cleaning member 86 may be supported by the support member 55. The support member 55 moves the rotation shaft 501 of the second transfer roller 50 upward and downward with rotation of the cam member 52, and concurrently moves the guide member 85 upward and downward. Thus, the sheet contact point W is adjusted.

The fourth example illustrated in FIG. 3B separately includes the support member 51, which supports the rotation shaft 501 of the second transfer roller 50, and the support member 87, which supports the guide member 85. The fourth example drives cam members 52 and 90 corresponding to the support members 51 and 87 with motors 53 and 89, and drives the rotation shaft 501 of the second transfer roller 50 and the guide member 85 so that the up-down movement of the rotation shaft 501 and the up-down movement or rotation of the guide member 85 are linked with each other.

The second transfer roller 50 and the guide member 85 may thus be driven by separate driving sources to be linked with each other.

In the case of the fourth example, the motor 89 of the guide member 85 and the cam member 90 correspond to an example of a guide controller in the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus, comprising:
a belt that holds and transports a toner image on an outer surface thereof;
an inner surface supporter that presses an inner surface of the belt, rotates about a first rotation shaft, and swells the belt toward the outer surface;
a transfer unit that rotates about a second rotation shaft while holding the belt between the transfer unit and the inner surface supporter, and presses a sheet transported thereto against the belt to transfer a toner image on the belt to the sheet;
a guide unit that guides the sheet transported thereto to an area interposed between the belt and the transfer unit; and
a guide controller that controls a position or an orientation of the guide unit so that a sheet contact point at which a leading end of the transported sheet comes into contact with the belt is located closer to the first rotation shaft, as the guided sheet is thinner, in a reference direction from the second rotation shaft toward the first rotation shaft.

2. The image forming apparatus according to claim 1,
wherein the guide controller controls the position or the orientation of the guide unit so that, when a sheet having a thickness smaller than a predetermined reference thickness is to be guided, the sheet contact point is located closer to the first rotation shaft in the reference direction than in a case where a sheet having a thickness larger than the reference thickness is to be guided.

3. The image forming apparatus according to claim 1, further comprising:
a pressure controller that controls pressure exerted from the transfer unit on the belt by moving the transfer unit toward and away from the belt,
wherein the guide controller controls the position or the orientation of the guide unit in a manner linked with movement control on the transfer unit performed by the pressure controller.

4. The image forming apparatus according to claim 2, further comprising:
a pressure controller that controls pressure exerted from the transfer unit on the belt by moving the transfer unit toward and away from the belt,
wherein the guide controller controls the position or the orientation of the guide unit in a manner linked with movement control performed on the transfer unit by the pressure controller.

5. The image forming apparatus according to claim 3,
wherein the guide controller is coupled to the pressure controller to control the guide unit with a power source shared with the transfer unit for movement control.

6. The image forming apparatus according to claim 4,
wherein the guide controller is coupled to the pressure controller to control the guide unit with a power source shared with the transfer unit for movement control.

7. The image forming apparatus according to claim 5,
wherein the guide controller is coupled to the pressure controller with the transfer unit interposed therebetween.

8. The image forming apparatus according to claim 6,
wherein the guide controller is coupled to the pressure controller with the transfer unit interposed therebetween.

9. The image forming apparatus according to claim 3, further comprising:
a cleaning unit that cleans the transfer unit while being in contact with the transfer unit, the cleaning unit changing the position or the orientation in accordance with movement control performed on the transfer unit by the pressure controller,
wherein the cleaning unit is the guide controller, and the guide unit changes the position or the orientation by changing the position or the orientation of the cleaning unit in accordance with the movement control on the transfer unit performed by the pressure controller.

10. The image forming apparatus according to claim 4, further comprising:
a cleaning unit that cleans the transfer unit while being in contact with the transfer unit, the cleaning unit changing the position or the orientation in accordance with movement control performed on the transfer unit by the pressure controller,
wherein the cleaning unit is the guide controller, and the guide unit changes the position or the orientation by changing the position or the orientation of the cleaning unit in accordance with the movement control on the transfer unit performed by the pressure controller.

11. The image forming apparatus according to claim 9,
wherein at least a surface of the cleaning unit that comes into contact with the transfer unit is formed from an elastic material.

12. The image forming apparatus according to claim 10,
wherein at least a surface of the cleaning unit that comes into contact with the transfer unit is formed from an elastic material.

13. The image forming apparatus according to claim 11,
wherein the elastic material is a sponge.

14. The image forming apparatus according to claim 12,
wherein the elastic material is a sponge.

15. The image forming apparatus according to claim 1,
wherein the guide controller controls the position of the guide unit in the reference direction to shift the sheet contact point in the reference direction.

16. The image forming apparatus according to claim 2,
wherein the guide controller controls the position of the guide unit in the reference direction to shift the sheet contact point in the reference direction.

17. The image forming apparatus according to claim 3,
wherein the guide controller controls the position of the guide unit in the reference direction to shift the sheet contact point in the reference direction.

18. The image forming apparatus according to claim 1,
wherein the guide controller controls a tilt angle of the guide unit with respect to the reference direction to shift the sheet contact point in the reference direction.

19. The image forming apparatus according to claim 2,
wherein the guide controller controls a tilt angle of the guide unit with respect to the reference direction to shift the sheet contact point in the reference direction.

20. An image forming apparatus, comprising:
a belt that holds and transports a toner image on an outer surface thereof;
an inner surface supporter that supports an inner surface of the belt while being in contact with the inner surface;
a transfer unit that rotates about a second rotation shaft while holding the belt between the transfer unit and the inner surface supporter, and presses a sheet transported thereto against the belt to transfer a toner image on the belt to the sheet;
a guide unit that guides the sheet transported thereto to a transfer area interposed between the belt and the transfer unit; and
a guide controller that controls a position or an orientation of the guide unit so that a sheet guided by the guide unit is discharged from the transfer area at an angle changed so that the sheet is spaced further from the belt as the sheet is thinner.
